(19) United States
(12) Patent Application Publication
(10) Pub. No.: US 2004/0211902 A1
(43) Pub. Date: Oct. 28, 2004

(54) Measuring device for determining the concentration of gases by infrared absorption

(76) Inventors: Hermann Stahl, Muhlheim (DE); Dieter Baschant, Vockerode (DE)

Correspondence Address: BAKER & HOSTETLER LLP, Washington Square, Suite 1100, 1050 Connecticut Avenue, N.W., WASHINGTON, DC, 20036, US

(21) Appl. No.: 10/774,410

(22) Filed: Feb. 10, 2004

(30) Foreign Application Priority Data
Aug. 10, 2001 (DE) DE 10138302.9

(51) Int. Cl. G01N 21/35

(52) U.S. Cl. 250/339.12

(57) ABSTRACT

The invention relates to a measuring device (10) for determining the concentration of gases by infrared absorption, comprising a radiation source (2) which is arranged, together with a radiation detector (6) disposed in the radiation path, inside a housing (11) which is sealed in a gas-tight manner in relation to the gas which is to be measured. At least one infrared permeable window is arranged in the radiation path between the radiation source (2) and the radiation detector (6). Said window seals the inside of the housing in relation to the gas which is to be measured. The radiation path is divided into at least three sections (21, 22, 23). The first section (21) is arranged between the radiation source (2) and a first infrared permeable window (3); the second section (22) is embodied in the form of a measuring section which has access to the gas and extends from the first infrared permeable window (3) to a second infrared permeable window (4); the third section (23) is disposed between the second infrared permeable window (4) and the radiation detector (6). The radiation detector (6) contains two detectors. The first is mounted in the form of a measuring detector and the other as a reference detector. The housing (11) of the measuring device has a thermal deformation resistance of up to at least 100° C.

The invention concerns a measuring device for determining the concentration of gases by infrared absorption with a modulable radiation source, which, together with two radiation detectors that are located in the beam path, one of which is connected as a measuring detector and the other as a reference detector, is situated in the interior of a housing, which is sealed gastight with respect to the gas to be measured, wherein a window, permeable to at least one IR radiation, is located in the beam path, between the radiation source and radiation detector, which seals off the interior of the housing with respect to the gas to be measured.

The spectral range designated as “infrared” is also indicated below as “IR radiation”.

From DE 197 13 928 C1, a measuring device for determining the concentration of gases by IR absorption with two similar radiation sources and two radiation detectors is known; it is able to deliver stable measurement values despite any occurring contamination or radiation blockage of the external, optical surfaces exposed to the gases or mixtures of gases, and any possible mechanical maladjustment. The two radiation detectors are provided with an optical concentrator for focusing the radiation and together with the two similar radiation sources and a beam splitter, are located in a gastight housing; wherein one radiation source is oriented via an IR-permeable window onto a flat mirror outside the gastight housing and the beam path reflected from the flat mirror falls on the beam splitter through the IR-permeable window. Thus, both the radiation of the first radiation source, reflected from the flat mirror, as well as that of the second radiation source are divided onto two radiation detectors, where the first radiation detector is used as the measurement detector and the second radiation detector as the reference detector.

The use of such known IR sensors for the CO₂ measurement in incubators must be regarded as problematic, since, in particular, the beam splitter, interference filter, and sensor part could be destroyed by CO₂ vapor mixture in the case of sterilization. Moreover, the IR radiation source with its reflector system can also be damaged by high temperatures—as may occur in the incubator, for example, during sterilization.

The problem of the invention is to provide a CO₂ gas sensor, based on IR analysis, which is capable of withstanding the high temperatures present during the sterilization phase, for the purpose of disinfection, without destroying the measurement electronics; furthermore, for the implementation of a quick measurement, is capable of measuring as small a CO₂ volume as possible.

The problem is solved in that the beam path is split into at least three partial sections, where the first section is located between the radiation source and a first IR-permeable window, the second section is formed as the measurement path accessible to the gas and extends from the first IR-permeable window to a second IR-permeable window, and the third section is located between the second IR-permeable window and the radiation detectors, wherein the housing has dimensional stability at temperatures of up to at least 100° C.

It has proven to be particularly advantageous that the sterilizable sensor requires a relatively low technical expenditure for production and maintenance.

Advantageous embodiments of the invention are indicated in Claims 2 to 11.

In a preferred embodiment of the invention, at least one beam splitter is located in the beam path of the radiation source; the actual measurement section is located in a cuvette, which seals off the housing with respect to the outside, wherein the dimensional stability with respect to heat extends up to a temperature of at least 100° C. The windows located in the beam path of the measurement section are made of calcium fluoride; the material of the cuvette (outside the windows) being aluminum or brass.

In a preferred embodiment, at least one absorption agent for carbon dioxide is found in the sealed interior of the housing.

Preferably, a single radiation source is provided, which has a reflector on the side turned away from the measurement. The radiation detectors, together with the beam splitter, are located in a detector module, which seals off the interior of the housing, and which is connected to the housing in a detachable manner.

The radiation source is located in an aluminum submodule which seals off the interior of the housing, which has a recess in the form of an ellipsoid for the formation of a reflector.

In a preferred embodiment of the invention, the measuring device consists of a modulable IR radiation source, a reflector, a cuvette, which is closed off by two IR-permeable windows, as a measuring chamber, which is connected to a measuring space that can be sterilized at a high temperature and that contains the gas to be measured. To obtain a measuring beam with the measurement wavelength and to obtain a reference beam with the reference wavelength, radiation detectors are provided with upstream optical filters for the conversion of the radiation output of the measuring and reference beams into electronic signals. The signals given off by the detectors are conducted to an evaluation circuit for the determination of the concentration of the gas components to be measured, wherein preferably, the difference and/or the quotient of the measuring and reference radiation outputs are formed. The cuvettete, the radiation source, the reflector, and the filter to obtain the measuring and reference beams, and the detectors for the measurement of the radiation output of the measuring and reference beams are located in a housing that is sealed gastight in such a way that a repeated heating and/or vapor sterilization of the measuring space does not cause any damage to the reflector, beam splitter, and waveguide element, filters, and selection elements and detectors, and in this way a long-term stable gas concentration measurement is made possible.

The measurement volume is small in proportion to the sensor volume, wherein the window material and the measuring chamber material are matched to one another with respect to their thermal expansion coefficients, so that thermal loads do not impair the tightness of the measuring chamber.

Between the measuring chamber and radiation source with the reflector as well as between the measuring chamber and the elements for filtering and obtaining the measuring and reference beams and for the measuring of the radiation output of the measuring and reference beams, such a distance and such a material is present that the thermal load during sterilization does not lead to impairment of the optical characteristics of the radiation source, the reflector, and the elements for filtering and obtaining the measuring and reference beams and for the measuring of the radiation output of the measuring and reference beams.

The proportion of the length of the measurement section to the length of the partial sections of the beam path, conducted in the interior of the housing, is in the range of 1:4 to 1:10.

The beam path between the radiation source and the radiation receiver is sealed off with respect to the measuring chamber and the surroundings in such a way that the beam path is almost measuring gas-free. The gas present in the beam path—outside the cuvette—is in contact with a gas space in which an absorption agent for the gas component to be measured is located, so that the absence of measuring gas in the beam path is guaranteed to be stable for the long term.

Furthermore, it is possible for the first and third partial sections of the beam path to be provided in interior spaces of the housing, which are themselves sealed off. In such a case, preferably, each of the two interior spaces is equipped with an absorption agent for the gas component (CO₂) to be measured.

In addition, heating means are present so as to raise the temperature of the measuring chamber and thus prevent condensation in the measuring chamber, wherein the housing, which surrounds the radiator, the measuring chamber, and the detectors, has dimensional stability with respect to temperatures up to at least 100° C.

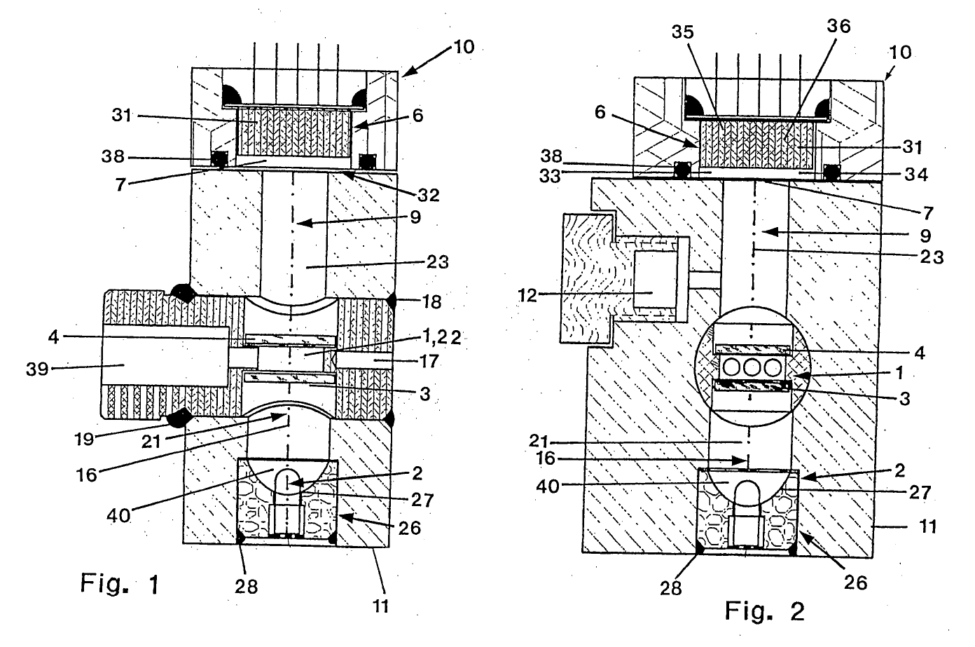

The object of the invention is explained in more detail below with the aid of FIGS. 1 and 2.

FIG. 1 shows in longitudinal section a measuring device with a cuvette containing the measuring gas, which is located in the beam path between an IR radiation source (heat source) and a sensor device with upstream filters.

FIG. 2 shows the cuvette, located in the measuring device, in cross section, wherein the beam path between the radiation source and sensor can also be discerned. Moreover, a specific space for an absorption agent for the absorption of the gas component to be measured can also be discerned.

In accordance with FIG. 1, a cuvette 1, containing the measuring gas, in particular, carbon dioxide, is located in the beam path between an IR radiation source 2 and an IR detector 6, in a measuring device 10; from the modulated IR radiation source 2, radiation passes through a first IR-permeable window 3, after passing through a first partial section 21, into the interior of cuvette 1 and after passing through the measuring section, as partial section 22, in the cuvette 1, it exits via a second IR-permeable window 4 of the cuvette 1. The radiation then passes through a prespecified partial section 23, and arrives at an IR detector 6 with an upstream filter system 7. The partial sections 21, 23, which are located within a sealed interior space 9 of the measuring device 10, are provided as free sections both between the IR radiation source 2 and the first IR-permeable window 3 and also between the second IR-permeable window 4 and the filter system 7 of the IR detector.

The interior 9 of the measuring device 10, closed off hermetically tight, has absorption agents in a reservoir 12, according to FIG. 2, which strongly reduce the CO₂ content of the measuring gas in the interior 9, so that a CO₂ content measurement in the cuvette 1 can in no way be destroyed by additional CO₂ fractions in the atmosphere of the interior 9.

The distances between the measuring cuvette 1 and IR radiation source 2, as a partial section, and between cuvette 1 and the filter system 7, as a partial section 23, are made large so that when using such a measuring device in an incubator, thermal decoupling is also possible between the interior of the cuvette 1 and the radiation source 2 and the detector 6 with the filter system 7 during the disinfection process, in the range of approximately 100° C., without damaging optical and electronic components.

The optical axis of the beam path, emanating from the IR radiation source 2, with its partial sections 21, 22, 23, is designated 16.

The housing 11 of the measuring device 10, which, in part, comprises the cuvette 1 and closes off the interior 9, is made of plastic, preferably, polyethylene tetraphthalate; however, it is also possible to use another thermally stable plastic.

The radiation source 2 is located, according to FIGS. 1 and 2, in an independent, rotationally symmetric reflector module 26 made of heat-resistant metal, wherein a heat source is used as an IR radiation source. The module 26 is connected to the housing 11, in a mechanically firm and gastight manner, during operation. A reflector 27 in a concave space 40 of the cylindrically symmetric module 26 is provided on the side of the radiation source 2, turned away from the cuvette 1; advantageously, the concave space 40 is shaped as part of a hollow ellipsoid in the module 26. In an advantageous embodiment, the reflector 27 does not have a coating.

The radiation source 2 emits IR radiation both in the wavelength range of 4.2 μm to 4.46 μm, affected by CO₂ absorption, and also in a spectral range, not affected by CO₂ absorption—for example, from 3.9 μm to 4.0 μm; a reference measurement is carried out in the wavelength range which is not affected by the CO₂ absorption.

The reflector module 26 is sealed off with respect to the housing 11 by means of a surrounding O-ring 28, wherein in case of a radiator defect, it can be simply loosened by screws and replaced with a replacement module.

The IR detector 6 is also located in an exchangeable, independent module 31, which seals off, with its front 32, the sealed interior 9, wherein the seal is realized by a surrounding O-ring 38.

In the area of the front 32 of the detector module 31, at least two interference filters 33, 34 are located, one of which, first filter 33, has high transmission only for the spectral range affected by CO₂ absorption, and the second filter 34 has high transmission only for a spectral range affected outside that of CO₂ absorption.

The two filters 33, 34 are connected upstream from a differently positioned detector area 35, 36, which produce electronic signals corresponding to the intensity of the pertinent radiation (that is, measuring and reference radiation), and which are conducted to an evaluated unit not shown here.

As can be seen from FIG. 1, the cuvette 1 has a heating device 17 on the end turned away from the CO₂ inlet 39, which heats the measurement volume to the extent that condensation in the measuring chamber of cuvette 1 is prevented. The sealing of the measuring cuvette 1′, with respect to the housing 10 of the measuring device, is carried out by surrounding O-rings 18, 19, whose thermal expansion coefficient is adapted to the material characteristics of the cuvette and housing of the measuring device. Furthermore, one can see that the IR detector 6 is connected to the filter system 7 mechanically tight via a surrounding silicone seal 38 on the housing 11 of the measuring device. The seal found in the area of the cuvette 1 are thereby highly heat-resistant, whereas the seal 28, 38 in the area of the IR radiation source 2 and IR detector 6 have a good temperature compatibility, so that during the vapor sterilization in the area of approximately 100°, they are exposed to lower temperature stress because of the distances or partial sections 21, 23 to the cuvette 1 than the seal 18, 19 located adjacent to the measuring cuvette 1.

In a particularly advantageous embodiment, one or more of the seals can be replaced by adhering the parts together.

The filter system 7 consists of interference filters 33, 34, of which the first filter is permeable only to the measurement wavelength in the absorption spectrum of CO₂, whereas the second interference filter 34 is provided only for the selection of the reference wavelength.

The measuring device 10 for determining the concentration of gases by infrared absorption can be sterilized with water vapor, without the sensor changing its operating state and without new calibration of the apparatus being necessary. The measuring cuvette 1 is heated to such an extent that the measuring chamber is always more than 4 K warmer than the surroundings or the sterilization temperature.

In order to lower the heat transfer to the detector module 31 and to the radiation source 2, which are located on the ends of the measuring device, they are separated by a cavity filled with an inert gas, which is made of a material with poor heat conduction with respect to the measuring cuvette 1. As a result of this arrangement, it is guaranteed that the highest temperature is always present at the measuring cuvette 1 and that water condensation takes place on other parts of the incubator. Prespecified limiting temperatures are not exceeded because of the low heat transmission factors to the detector module 31 and its measuring and reference detectors 35, 36 and to the radiation source 2. The materials are generally selected according to their thermal expansion coefficients.

Thermal insulation of the sensors also occurs as a result of a cavity between the detector areas 35, 36 and the sealed housing 11 with the beam path 22.

1. Measuring device for determining the concentration of gases by infrared absorption with a modulable radiation source, which, together with two radiation detectors that are located in the beam path, one of which is connected as a measuring detector and the other as a reference detector, is located in the interior of a housing, which is sealed, gastight with respect to the gas to be measured, wherein at least one infrared-permeable window, which closes off the interior of the housing with respect to the gas to be measured is located in the beam path between the radiation source and the radiation detectors, characterized in that the beam path is split into at least three partial sections (21, 22, 23), of which the first section (21) is located between the radiation source (2) and a first infrared-permeable window (3), that the second section (22) is formed as the measurement section accessible to the gas and extends from the first infrared-permeable window (3) to a second infrared-permeable window (4), and that the third section (23) is located between the second infrared-permeable window (4) and the radiation detectors, wherein the housing (11) has dimensional stability with respect to temperatures up to at least 100° C.

2. Measuring device for determining the concentration of gases by infrared absorption in an incubator with a radiation source and two radiation detectors found in the beam path, one of which is a measuring detector and the other a reference detector, and with a housing (11), which is sealed gastight with respect to the gas to be measured, characterized in that a measuring cuvette (1) with a heating device (17) for the heating of a measuring chamber is provided.

3. Measuring device according to claim 1, characterized in that at least one beam splitter is located in the beam path of the radiation source (2).

4. Measuring device according to claim 1, characterized in that the measuring section (22) is located in a measuring cuvette, whose dimensional stability with respect to heat extends up to a temperature of at least 100° C. and which seals off the housing (11) with respect to the outside.

5. Measuring device according to claim 4, characterized in that the windows (3, 4), which are located in the beam path of the measuring section (22), are made of calcium fluoride.

6. Measuring device according to one of claim 1, characterized in that aluminum or brass is used as the material of the cuvette (1) outside the windows.

7. Measuring device according to one of claim 1, characterized in that a first and a third partial section (21, 23) of the beam path are located in interior spaces of the housing (11), which are themselves sealed.

8. Measuring device according to one of claim 1, characterized in that at least one absorption agent for carbon dioxide is found in the sealed interior of the housing (11).

9. Measuring device according to one of claim 1, characterized in that the ratio of the length of the measuring section (22) to the length of the partial sections (21, 23) of the beam path, which passes through the interior of the housing is in the range of 1:4 to 1:10.

10. Measuring device according to one of claim 1, characterized in that a single radiation source (2) is provided, which has a reflector (27) on the side turned away from the measurement.

11. Measuring device according to one of claim 1, characterized in that the radiation detectors, together with the beam splitter, are located in a detector module (31), which seals off the interior of the housing (11) and which is connected to the housing in a detachable manner.

12. Measuring device according to one of claim 1, characterized in that the radiation source (2) is located in a submodule made of aluminum, which seals off the interior of the housing and which has a recess in the form of an ellipsoid for the formation of a reflector (27).
